(19) United States
(12) Patent Application Publication
(10) Pub. No.: US 2017/0024193 A1
(43) Pub. Date: Jan. 26, 2017

(54) METHOD AND DEVICE FOR MANAGING AMBIGUITIES IN THE ANALYSIS OF A SOURCE CODE

(71) Applicant: COMMISSARIAT A L'ENERGIE ATOMIQUE ET AUX ENERGIES ALTERNATIVES, PARIS (FR)

(72) Inventor: Thierry GOUBIER, Velizy (FR)

(21) Appl. No.: 15/123,937

(22) PCT Filed: Feb. 27, 2015
(86) PCT No.: PCT/EP2015/054187

§ 371 Date: Sep. 6, 2016

(30) Foreign Application Priority Data
Mar. 10, 2014 (FR) 1451922

(51) Int. Cl. G06F 9/45

(52) U.S. Cl. CPC G06F 8/425

(57) ABSTRACT

A device allows a lexical analyzer to generate selective tokens for a syntactic analyzer, differentiating ambiguous lexical entities. In particular, the device is applicable to the removal of ambiguities in the grammar of the C language defined in ISO/ANSI C standard.

### FIELD OF THE INVENTION

The invention relates to the field of source code compilation and, in particular, pertains to a method and a device for managing ambiguities in the analysis of source code.

### PRIOR ART

In order to transform the source code of a computer program written in a source language into an object code in a target language, compilers carry out, in a first phase, analysis operations via three main components. The analysis steps include, in general, a first step of lexical analysis carried out by a lexical analyzer, also known as a ‘scanner’, which breaks the source code down into lexical entities called tokens. The token are subsequently used by a syntactic analyzer (or parser) in order to identify the syntactic structure of the program. A syntax tree structure is generally constructed on the basis of the tokens according to a grammar which defines the syntax of the language. A semantic analyzer allows the syntax tree to be completed and a table of symbols, containing the definitions of the symbols of the source code, to be produced. The tree arising from the analysis sequence is subsequently used by other components of the compiler in order to generate the target code.

The grammar associated with a C language compiler has been defined by the International Organization for Standardization (ISO) according to ISO/IEC standard 9899:1999 in order to specify, inter alia, the syntax and semantic rules of the C language. This standard has evolved and currently bears the reference ISO/IEC 9899:2011.

The C language grammar defined in this standard introduces ambiguities into the syntactic analysis of the language regarding the symbols that are found in the known statements “typedef-name” and “identifier” referred to in the standard in chapter “6.7.8 ISO/IEC 9899:2011”.

Specifically, the grammar of a programming language such as the C language is a set comprising symbols and production rules. There are two types of symbols: “terminal symbols”, corresponding to a lexical entity of the language, and “non-terminal symbols”. One of the non-terminal symbols is designated as the starting point of the grammar. A production rule defines the way in which a set of symbols belonging to the grammar may correspond to a new symbol. The syntactic analysis consists then in constructing a tree on the basis of a source code broken down into lexical entities, which tree is commonly called a parse tree whose root is the starting point of the grammar, whose leaves are the terminal symbols, and each node of which is created by applying the production rules.

Thus, the grammar of the C language allows the syntactic elements of the language to be defined as instructions, via the symbols of the grammar, and the role of the various lexical elements (punctuation, names) in the formation of correct sentences to be defined via the production rules of the grammar. This grammar, as stated above, is ambiguous and may, for one and the same sequence of characters such as the sequence “a*a”, result in multiple different constructions.

For example, the syntactic element named “statement” may be confused with the element named “expression”, yet the two elements do not have the same meaning at all. Specifically, a “statement” consists in defining a “symbol” in the program and associating a “type” therewith, i.e. information describing the data associated with or designated by this symbol such as numerical values (integers, real numbers, etc.), text or composite (complex) elements. In the grammar, “statement” elements are then found that have a left-hand portion corresponding to a “type description” and a right-hand portion corresponding to a “symbol name”, the whole commonly forming a “type/symbol” association.

However, an exception to the type/symbol association exists for statements whose description is “typdef” and whose symbol name is “typedef-name”. Such a symbol name may appear in the remainder of the source code only in another type description, namely in the right-hand portion of another statement. Apart from this exception, such a symbol may only be found in a type description.

It is possible, under certain conditions, to redefine a symbol, and associate a different type description therewith. It is thus entirely conceivable to redefine a “typedef-name” symbol as a symbol of another type. For example, with the following set of characters:

“a*a” may be interpreted as a “statement” having the left-hand portion “a*” as the type description and the right-hand portion “a” as the symbol definition, if the element “a” has been previously defined as a “typedef-name” symbol.

However, if the symbol “a” has not been previously defined as a “typedef-name”, this same sentence “a *a” encountered in the code may take on an entirely different meaning and be an expression describing a calculation, in this instance the multiplication of the value represented by “a” by itself.

There are solutions allowing these ambiguities to be managed.

One approach consists in systematically contextualizing the lexical analyzer, the syntactic analyzer and the semantic analyzer by associating therewith a memory for recording the definitions of the symbols in a table, called a table of symbols.

The principle of contextualization operates according to the following functional breakdown:

the semantic analyzer identifies the definition of a symbol and the type description associated with this symbol and records it in the table of symbols;

on encountering a name (for example “a”) in the incoming source code, the lexical analyzer interrogates the table of symbols in order to determine whether the name has already been defined and in what way. If the encountered name is already defined as “typedef-name”, the lexical element is associated with a “typedef-name” token; otherwise the lexical element is associated with an “identifier” token.

However, an implication of this approach is that the rule listed in the ISO/IEC standard 9899:2011 in chapter 6.7.8 needs to be removed from the grammar:
typedef-name:
   identifier
      and that the “typedef-name” symbol needs to become a terminal symbol of the grammar, i.e. a token produced by the lexical analyzer.

On the basis of this modification, various implementations of C analyzers, both compilers and analysis tools, have been developed.

A first type of implementation consists in extending the grammar of the C standard and allowing the occurrence of “typedef-name” tokens arising from the contextual lexical analysis. This aims to make the statement “a*a” syntactically correct in the case in which ‘a’ is a “typedef-name” token. This implementation, referred to as an extended grammar, is used in existing compilers such as ‘GCC’ (GNU Compiler Collection) in versions prior to V4.0 or ‘PCC’ (Portable C Compiler) and it is also used in C analysis tools such as the ‘CIL’ (C Intermediate Language), ‘Frama-C’ or else ‘FrontC’ tools. However, the grammar of the C standard only permits the generation of “identifier” tokens in a statement, and producing an extended grammar is a complex operation running a high risk of introducing new ambiguities.

Another drawback is that an extended grammar is substantially longer than the grammar of the C standard, thus increasing the complexity of the syntactic analysis. Specifically, once an extended grammar has been obtained, the development of an analyzer consists in generating the implementation of the syntactic analyzer via a compiler generator like the compilers ‘Berkeley or AT&T YACC’, ‘GNU bison’ or else ‘USF ANTLR’, for example. It is the generator that is responsible for the development of the remainder of the syntactic analyzer and ensures that the behavior of the syntactic analyzer thus implemented and the interaction thereof with the lexical analyzer and with the semantic analyzer is in accordance with the grammar.

Another type of implementation consists in abandoning the grammar of the C standard and manually rewriting the syntactic analyzer, for example in the C or C++ language. This technique, referred to as recursive descent parsing as it presupposes a certain type of analyzer, has the drawback of being simple to operate only for a more limited class of grammars, which does not include the grammar of C. The syntactic analyzer thus developed is generally very complex, both in amount of code and in behavior, and provides no guarantee of conformity apart from via manual transcription, element by element, of the standard of the analyzed language. Moreover, it requires a costly test procedure, which in any case still does not guarantee complete conformity.

Tools using this technique are, for example, ‘GNU GCC’, based on version 4.0, or ‘Apple CLANG’.

Another type of known implementation consists in considering a partial analysis of the source code to be sufficient for the purposes of the implementation, and then a complete solution to the problem of ambiguity to be unnecessary. In this case, the syntactic analyzer is considered to be incapable of validating the entirety of the correct syntaxes, but it is capable of readjusting via ad-hoc strategies when it encounters an ambiguous line. Tools such as ‘LIP6 Coccinelle’ or code re-engineering tools use this approach, their objectives being met through a partial syntactic analysis of the source code. Such an approach is not suitable for a compilation tool.

Thus the known solutions have drawbacks and do not meet the need for a standardized grammar that is usable, without changes, in a source code compiler.

There is thus a need to provide a device and a method for managing the ambiguities relative to symbol statements for a standardized grammar. The proposed invention makes it possible to meet this need.

### SUMMARY OF THE INVENTION

One object of the present invention is to propose a method that exploits a standardized grammar, without modifying it or resorting to an extended grammar, to manage the ambiguities in symbol statements.

The device of the present invention allows the lexical analyzer to generate selective tokens differentiating multivocal or ambiguous lexical entities.

The technical advantages of the present invention are to substantially reduce the complexity of a syntactic analyzer, both in terms of software development cost by virtue of a smaller amount of code and in terms of the validation thereof as it ensures closest possible compliance with the standard rather than revalidating extensions that are not defined in the standard.

Another object of the present invention is to propose a method allowing an indicator of differentiation of issued tokens to be activated within the lexical analyzer.

Advantageously, the invention is applicable to source code compilers and analyzers of the C programming language, as well as extensions thereof. In particular, the invention is applicable to the field of analysis and development tools, compilers and code verification tools for software engineering and assurance.

In order to obtain the desired results, a device, a method and a computer program product are proposed.

In particular, a device coupled to a lexical analyzer comprises components adapted to:
identify, in a source code received by the lexical analyzer, a lexical entity having an interpretational ambiguity relative to a grammar of a given language;
identify, in a table of symbols associated with the lexical analyzer, the presence of a symbol for said lexical entity;
determine, for the identified symbol, a definition recorded in the table of symbols; and
generate a token that is representative of the definition.

Advantageously, the components for identifying a lexical entity having an interpretational ambiguity comprise means for determining whether the lexical entity is a name corresponding to a lexeme of “typedef-name” type.

In one embodiment, the device comprises means for defining, in the grammar, a first area in which “typedef-name” lexemes are differentiated from “identifier” lexemes, and a second area in which said lexemes are not differentiated.

Advantageously, the device comprises means for generating an ‘identifier’ token if the name is in the second area of the grammar.

In one embodiment, the device comprises means for activating a search in a table of symbols if the name is in the first area of the grammar.

In one variant, the components for determining the recorded symbol definition additionally comprise means for determining whether the symbol is defined as “typedef-name”. According to this variant, the components for generating a token comprise means for generating a ‘typedef-name’ token. In another variant, the components for generating a token comprise means for generating an ‘identifier’ token if the symbol is not defined as “typedef-name”.

Advantageously, the source code is in C language and the grammar is the standardized grammar of the C language.

In one preferred implementation, the device is implemented in a code compiler.

The invention additionally relates to a method for managing the interpretational ambiguities relative to a grammar of a given language, the method comprising the following steps:
identifying, in a source code received by a lexical analyzer, a lexical entity having an interpretational ambiguity;
identifying, in a table of symbols associated with the lexical analyzer, the presence of a symbol for said lexical entity;
determining, for the identified symbol, the definition recorded in the table of symbols; and
generating a token that is representative of said definition.

The invention may operate in the form of a computer program product that comprises code instructions allowing the steps of the claimed method to be carried out when the program is executed on a computer.

### DESCRIPTION OF THE FIGURES

Various aspects and advantages of the invention will become apparent from the description of one preferred, but non-limiting, mode of implementation of the invention, which is given with reference to the figures below:

FIG. 1 schematically shows the components of the device of the invention in a preferred implementation;

FIGS. 2a and 2b show a sequence of the steps of the method of the invention in one embodiment.

### DETAILED DESCRIPTION OF THE INVENTION

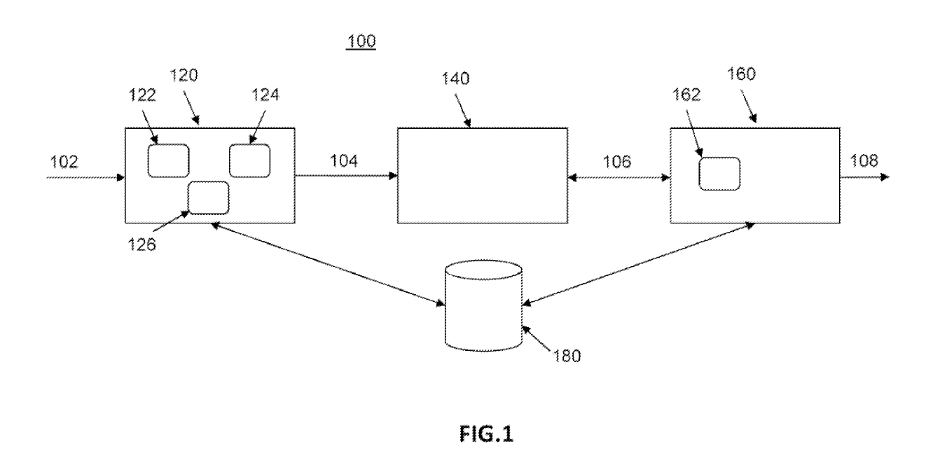

Reference is made to FIG. 1, which schematically shows a device 100 comprising the components of a lexical, syntactic and semantic analysis sequence for a preferred implementation of the invention in a C compiler.

A lexical analysis module 120 receives the source code 102 in C language. The C source code may originate from a file stored on the computer implementing the device 100, from a remote computer, or from any other medium that can be read by a computer. The lexical analysis module 120 comprises a set of analytical components 122, common to any lexical analyzer, for receiving the source code and breaking it down into lexical entities.

The lexical analyzer according to the invention additionally comprises a state-changing component 124 for toggling a state indicator from a ‘true’ state to a ‘false’ state and vice versa. In one preferred implementation, the component is implemented in the form of an “application programming interface” (API) comprising the functions allowing the state indicator to change state.

The lexical analyzer 120 additionally comprises a test component 126 for testing the value of the state indicator. The test allows the value of the state indicator to be verified in order to determine the nature of the token to be issued, either an “identifier” token or a “typedef-name” token. The lexical analysis module issues tokens 104 to a syntactic analysis module 140.

The syntactic analysis module 140 analyzes the tokens received from the lexical analyzer, generates a syntax tree based on the grammar used, and generates semantic actions (AST) 106 which are processed by a semantic analysis module 160. In one preferred implementation, the syntactic analysis module allows the grammar of the ISO/ANSI C standard to be used without extension, from which the production listed in chapter “6.7.8 ISO/IEC 9899:2011” is removed.

The grammar of the C language is analyzed so as to determine a first area in which it is necessary to draw the distinction between the “typedef-name” and “identifier” entities, and a second area in which it is not necessary to draw this distinction. In order to facilitate understanding of the invention, throughout the remainder of the description the distinguishing area is referred to as the “active area” and the non-distinguishing area is referred to as the “passive area”. Furthermore, the grammar is considered to represent a space in which the syntactic analysis consists of moving within this space in accordance with a chosen method of syntactic analysis. Each production of the grammar (and the non-terminal in the left-hand portion of the production) represents a point in this space and the paths allowing it to be reached. Each point in this space may have one or more semantic actions attributed thereto, which are carried out once the syntactic analyzer has finished its analysis at this point.

When a point is located on the border between the two active and passive areas, a semantic action is associated with this point in order to activate the state-indicating component of the lexical analyzer, according to two cases:

if the movement within the space consists of passing from the active area to the passive area, the state-changing component 124 is activated in order to toggle the state indicator from the true state to the false state;

if the movement within the space consists of passing from the passive area to the active area, the state indicator is toggled from the false state to the true state.

The semantic analysis module 160 receives the semantic actions issued by the syntactic analyzer in order to process them and to complete the syntax tree. It comprises a component 162 for defining the division of the grammar into areas, which defines the border between the active area and the passive area.

The semantic analysis module is additionally coupled to a memory 180. In one preferred embodiment, the memory is organized as a table of symbols which allows the definitions of the symbols to be recorded. The memory is also coupled to the lexical analysis module.

The elements (108) generated by the semantic analysis module are addressed to components of the compiler (not shown in the figure) in order to finalize the code generation and optimization operations.

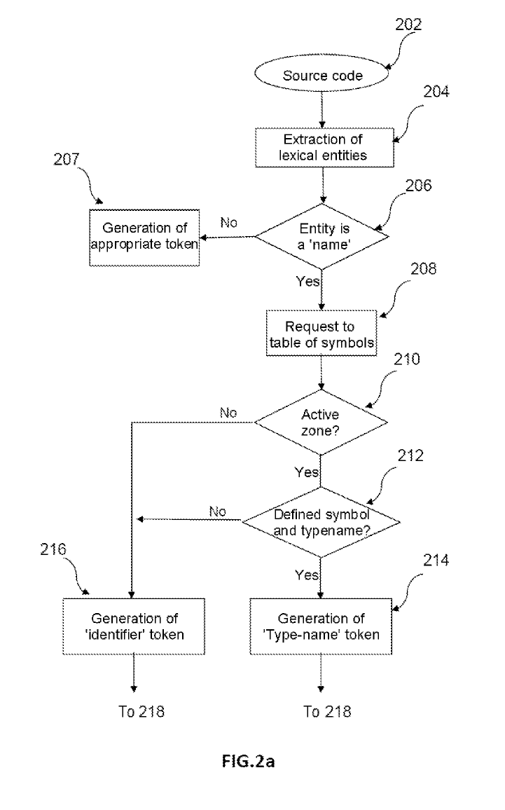

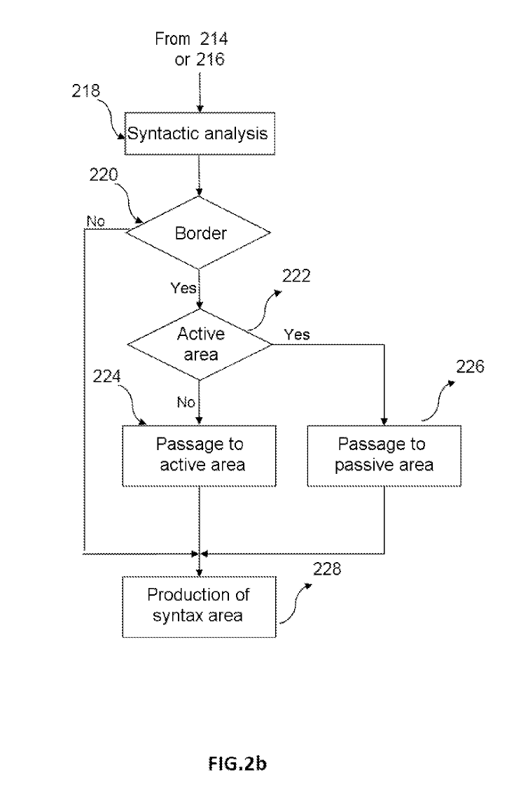

FIGS. 2a and 2b illustrate the steps 200 carried out by the sequence of components of FIG. 1 in a preferred implementation of the invention.

In FIG. 2a, the method starts with reading a set of characters of a source code 202 submitted to the lexical analyzer. The following step 204 consists in extracting lexical entities from the source code. In one embodiment, the present invention is implemented in a TC compiler, in its C analysis portion, using the Smalltalk® language in which the structural concepts are classes, objects (the instances of classes), methods (the behaviors of objects) and attributes (the state variables of objects). The lexical analyzer is a “lexer” class called CCScanner responsible for the lexical analysis. The device comprises a “parser” class called CCParser corresponding to the syntactic analyzer responsible for the syntactic analysis and a portion of the semantic analysis. The device additionally comprises a class for managing the table of symbols, called CScope. In this preferred implementation, the compiler generator used is Smalltalk Compiler-Compiler (SmaCC) which defines the abstract classes containing the behavioral base of the lexical analyzer and of the syntactic analyzer, as well as the compiler of analyzers on the basis of the grammar and the lexical description.

Once the lexical entities have been extracted, the method allows, in step 206, it to be tested whether an entity is a name corresponding to a lexeme of “typedef-name” type or not. If the entity is not of “typedef-name” type (No branch), the lexical analyzer produces a token appropriate to the type of entity (207). If the lexical entity is a name (Yes branch), the method sends a request (208) to the table of symbols to search for the symbol associated with the entity. The symbol is sent back to the lexical analyzer.

The method allows it to be verified (step 210) in which area of the grammar the entity is encountered, in order to determine whether the entity is in the active or passive grammar area. If the encountered entity is in the passive grammar area (No branch), i.e. the symbol has already been encountered and there is no ambiguity in its interpretation, the lexical analyzer will produce a token of ‘identifier’ type (step 216).

If the encountered entity is in the active grammar area (Yes branch, step 210), meaning that there is an ambiguity in its interpretation, the method continues to the following step (212) in order to verify whether the symbol is defined for this entity in the table of symbols, and how it is defined (type or variable). If the symbol is defined and it is specified by its type as “typedef-name” (Yes branch), the method continues to step 214 in which the lexical analyzer produces a ‘typedef-name’ token. If the symbol has not been previously defined, or if the symbol is defined but not specified as “typedef-name” (No branch), the method continues to step 216 in which the lexical analyzer produces an ‘identifier’ token (step 216).

In one embodiment implemented in a TC compiler, the CCScanner class defines an “fTypename” attribute initialized to the value ‘true’ upon creation of an instance of the scanner via the (CCScanner>>initialize) method. The control API of the device comprises two methods, (CCScanner>>setFTypename) and

(CCScanner>>unsetFTypename), the first setting the attribute to ‘true’ and the second setting the attribute to ‘false’. If a ‘setFTypename’ message is sent to a CCScanner instance, the attribute is set to ‘true’, and if an ‘unsetFTypename’ message is sent to a CCScanner instance, the attribute is set to ‘false’. It will be noted that multiple instances may independently coexist in the program, with decorrelated states.

The CCScanner lexical analyzer has a ‘CCScanner>>IDENTIFIER’ routine which is launched when a lexeme of the “identifier” type is detected at input. Contextualization is implemented by making a request to the table of symbols (an instance of CScope). The implementation is carried out via a test on the fTypename attribute according to the following logical expression:
(fTypename and: [symbol notNil and: [symbol is Typename]])
   meaning that if fTypename is equal to ‘true’, that the symbol exists (prior presence of a statement in the analyzed source code) and that it is defined as a ‘type’, then due to all of these conditions, the lexical analyzer produces a token of TypeNameld type, otherwise it produces a token of IDENTIFIERId type.

Returning to FIG. 2b, after the production of a token, either an ‘identifier’ (216) or a ‘typedef-name’ (214) token, the method continues to step 218 via the syntactic analysis and execution of the semantic actions (106).

The method then allows it to be verified (step 220) whether a point in the analysis is located on the border of the active area and the passive area. If the point is not on the border (No branch), the method allows the syntax tree to be generated (step 228). If the point is located on the border of the two areas (Yes branch), the method allows the direction of movement within the space (222) to be determined and it to be verified from which area of the grammar the entity originates. If the area of origin is the active area (Yes branch), meaning that the direction of movement consists of passing from the active area to the passive area, the method allows the area passage device to be actuated (step 224). Next, the method allows the syntax tree to be generated (228), taking the modifications into account.

If, during verification in step 222, the area of origin is the passive area (No branch), meaning that the movement within the space consists of passing from the passive area to the active area, the method allows the device for passage to the active area to be actuated (step 226). Next, the method allows the nodes of the syntax tree to be generated (228), taking the modifications and the corresponding semantic actions into account.

In one preferred implementation integrated in the TC compiler, the border between the two areas is implemented in the semantic analyzer and the areas are realized in the semantic actions defined in the grammar, according to the following embodiment:

for passing from the active area to the passive area: the semantic action contains the code ‘self unsetFTypename’ which activates the components of the lexical analyzer.

for passing from the passive area to the active area: the semantic action contains the code ‘self setFTypename’ which deactivates the components of the lexical analyzer.

By way of example according to one implementation for the grammar of the C language, for an analysis starting in the active area, the borders between the two areas are identified at the following points:
for passing from the active area to the passive area:
Production: init_comma: [symbol] , [symbol] in init_declaration_list
Production: declaration_specifiers: declaration_specifier
Production: type_specifier
   : “void” {self unsetFTypename. . . . }
         |“char” {self unsetFTypename. . . . }
         |“short” {self unsetFTypename. . . . }
         |“int” {self unsetFTypename. . . . }
         |“long” {self unsetFTypename. . . . }
         |“float” {self unsetFTypename. . . . }
         |“double” {self unsetFTypename. . . . }
         |“signed” {self unsetFTypename. . . . }
         |“unsigned” {self unsetFTypename. . . . }
         |“_Bool” {self unsetFTypename. . . . }
         |“_Complex” {self unsetFTypename. . . . }
         |struct_or_union_specifier {self unsetFTypename. . . . }
         |enum_specifier {self unsetFTypename. . . . }
         |<TypeName> {self unsetFTypename. . . . }
   ;
Production: kr_declaration_specifiers:
   kr_declaration_specifier {self unsetFTypename. . . . }
   ;
      for passing from the passive area to the active area:
Production: declaration
   : declaration_specifiers “;” {self setFTypename. . . . }
Production: direct_declarator
   : <IDENTIFIER>
      {self setFTypename. . . . }
Production: parameter_declaration
         |declaration_specifiers abstract_declarator {self setFTypename. . . . }
         |declaration_specifiers {self setFTypename. . . . }
Production: type_name
   : specifier_qualifier_list {self setFTypename. . . . }
         |specifier_qualifier_list abstract_declarator{self setFTypename. . . . }
Production: param_paren
   : “(” {self setFTypename. . . . }
Production: left_block
   : <LEFT_BLOCK> {self setFTypename. ̂‘1’}

In an alternative embodiment, depending on the technology of the syntactic analyzer, an optional device may be added to the lexical analyzer in order to carry out a verification on a look-ahead token. During a change of state of the state indicator “typedefname” for such a token, which has already been read and generated by the lexical analyzer but not yet completely processed by the syntactic analyzer, if it is an “identifier” token and the device is set to “true”, the token is then reverified in order to be turned into a “typedef-name” token if the action is appropriate. If it is a “typedef-name” token and the device is set to “false”, the token is turned into an “identifier” token.

In one preferred implementation integrated in the TC compiler, the optional device is produced in the lexical analyzer in the form of an API corresponding to the (CCParser>>setFTypename) and (CCParser>>unsetFTypename) device, which API is capable of operating the optional device in the following manner:

The token being processed is contained in the “currentToken” attribute of the syntactic analyzer. If the (setFTypename) device is active, the token is an “IDENTIFIERId” and its symbol exists and is a type, then the token is changed into a “TypeNameld”.

If the (unsetFTypename) device is deactivated and the token is a “TypeNameld”, then it is changed into an “IDENTIFIERId”. In the other cases, the token being processed is not modified.

Thus the method allows the ambiguities potentially occurring in symbol statements to be managed.

The present invention may be implemented using software and/or hardware elements. It may be available as a computer program product on a medium that can be read by computer. The medium may be electronic, magnetic, optical, electromagnetic or be a relay medium of infrared type. Examples of such media are semiconductor memories (random access memory RAM, read-only memory ROM), tapes, floppy disks or magnetic or optical disks (compact disc—read-only memory (CD-ROM), compact disk—read/write (CD-R/W) and DVD).

1. A device for managing ambiguities in a source code, comprising software components adapt to:
identify, in a source code received by a lexical analyzer, a lexical entity having an interpretational ambiguity relative to a grammar of a given language, said grammar possibly being defined by a first area in which “typedef-name” lexemes are differentiated from “identifier” lexemes, and a second area in which said lexemes are not differentiated;
determine whether the lexical entity is a name corresponding to a lexeme of “typedef-name” type and whether the name belongs to the first area of the grammar;
if so, identify, in a table of symbols associated with the lexical analyzer, the presence of a symbol for said lexical entity and the recorded definition for said symbol; and
generate a ‘typedef-name’ token.

2. The device as claimed in claim 1, additionally comprising means for generating an ‘identifier’ token if the name corresponds to a lexeme of “typedef-name” type and belongs to the second area of the grammar.

3. The device as claimed in claim 1, wherein the components for generating a token comprise means for generating an ‘identifier’ token if the symbol is not defined in the table of symbols as “typedef-name”.

4. The device as claimed in claim 1, wherein the source code is in C language and the grammar is the standardized grammar of the C language.

5. A code compiler comprising the software components of the device as claimed in claim 1.

6. A method for managing the interpretational ambiguities relative to a grammar of a given language, said grammar possibly being defined by a first area in which “typedef-name” lexemes are differentiated from “identifier” lexemes, and a second area in which said lexemes are not differentiated, the method comprising the following steps:
identifying, in a source code received by a lexical analyzer, a lexical entity having an interpretational ambiguity;
determining whether the lexical entity is a name corresponding to a lexeme of “typedef-name” type and whether the name belongs to the first area of the grammar;
if so, identifying, in a table of symbols associated with the lexical analyzer, the presence of a symbol for said lexical entity and the recorded definition for said symbol; and
generating a ‘typedef-name’ token.

7. A computer program product, said computer program comprising code instructions allowing all or part of the steps of the method as claimed in claim 6 to be carried out, when said program is executed on a computer.
